(19) United States
(12) Patent Application Publication
(10) Pub. No.: US 2013/0047184 A1
(43) Pub. Date: Feb. 21, 2013

(54) Utility Usage Presentation with Program Listings

(71) Applicant: Roger Musick, Mitchell, SD (US)

(72) Inventor: Roger Musick, Mitchell, SD (US)

(21) Appl. No.: 13/212,300

(22) Filed: Aug. 18, 2011

(51) Int. Cl. H04N 5/445

(52) U.S. Cl. 725/40

(57) ABSTRACT

A system to present program schedule information and utility usage information. An apparatus to generate display signals directing a display to present a program schedule that includes program schedule information and utility usage information. A method of presenting program schedule information with utility usage information.

### BACKGROUND

1. Technical Field

This invention generally relates to entertainment systems, and more particularly relates to the presentation of information in the entertainment system.

2. Description of Related Art

The first step in conservation is understanding consumption. There are systems in place that show users the current utility usage, however to be effective, the user's attention needs to be directed to these devices. What is needed is a method to inform the user of energy usage in a medium to which the user's attention is already directed.

### SUMMARY

A method, apparatus and computer program product for presenting information relating to utility usage includes receiving program schedule data and utility usage data and directing a display to present a program schedule that includes a representation of the program schedule data with a representation of the utility usage data.

### BRIEF DESCRIPTION OF THE DRAWINGS

The accompanying drawings, which are incorporated in and constitute part of the specification, illustrate various embodiments of the invention. They should not, however, be taken to limit the invention to the specific embodiment(s) described, but are for explanation and understanding only. In the drawings:

FIG. 1 is a representation of an embodiment of a program schedule including utility usage information;

FIG. 2 shows a data flow diagram of an embodiment of a system for presenting a program schedule including utility usage information;

FIG. 3 shows a perspective view of an embodiment which provides a program schedule including utility usage information;

FIG.4A shows a data flow diagram of an embodiment with a utility meter communicating utility usage data to the interface;

FIG. 4B shows a data flow diagram of an embodiment with a utility meter communicating utility usage data to a utility provider and the utility provider communicating utility usage data to the interface;

FIG. 4C shows a data flow diagram of an embodiment with a power strip and SMART outlets communicating utility usage information to the interface;

FIG. 5A is a representation of detailed utility usage information;

FIG. 5B is a representation of utility usage information per device;

FIG. 6 is a representation of detailed utility usage information with a program displayed in a window;

FIG. 7 is a representation of a program schedule including utility usage information where the program schedule is presented on less than the full screen

FIG. 8 is a flow chart of an embodiment for a method for presenting a program schedule including utility usage information; and

FIG. 9 is a hardware block diagram of an embodiment of an interface suitable for use in presenting a program schedule including utility usage.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures and components have been described at a relatively high-level, without detail, in order to avoid unnecessarily obscuring aspects of the present concepts. A number of descriptive terms and phrases are used in describing the various embodiments of this disclosure. These descriptive terms and phrases are used to convey a generally agreed upon meaning to those skilled in the art unless a different definition is given in this specification.

Reference now is made in detail to the examples illustrated in the accompanying drawings and discussed below.

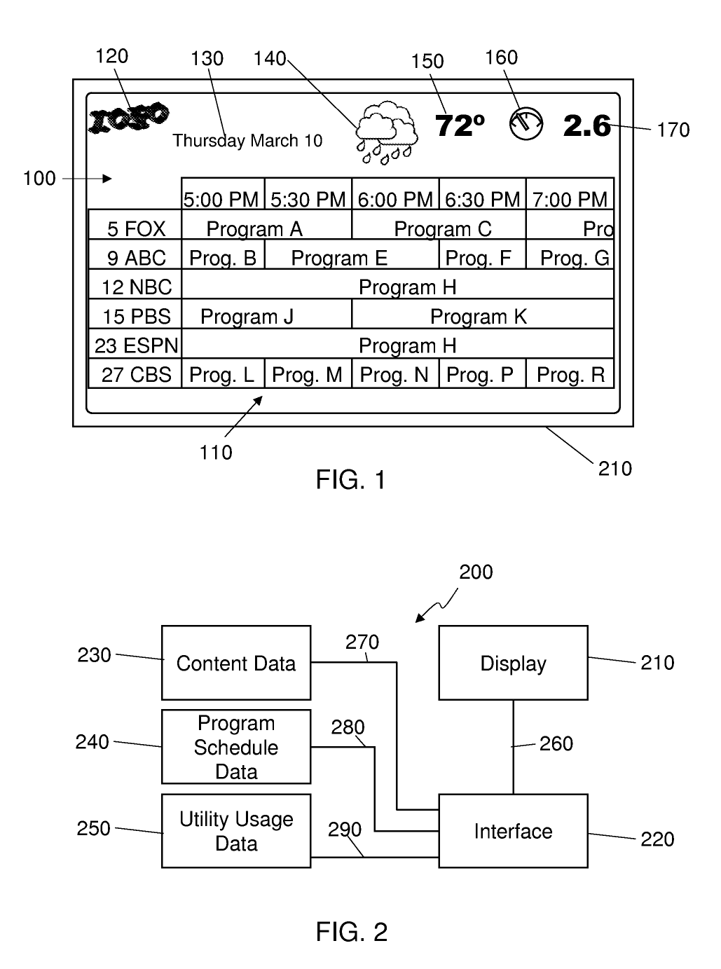

FIG. 1 is a representation of an embodiment of a display image 100 including a program schedule 110, a logo 120, a date 130, a weather indicator 140, a temperature value 150, a utility usage indicator 160, and utility usage value 170. Some embodiments may not include all the elements described and other embodiments may include additional elements in the display image 100 in place of or in addition to the elements described.

In some embodiments, the utility being indicated by the utility usage indicator 160 and the utility usage value 170 may be electricity. In other embodiments, the utility may be, for example, water, natural gas, fuel oil, any other metered utility or a combination of utilities. In some embodiments the utility is consumed, such as electricity and natural gas. In other embodiments the utility may be waste generated by the consumer such as sewer, or carbon output.

In at least one embodiment, the utility usage indicator 160 may be a colored circle with distinct colors representing utility usage. In such embodiments the utility usage indicator 160 may be green when the utility usage is below a lower threshold, the utility usage indicator 160 may be yellow when the utility usage is between the lower threshold and an upper threshold, and the utility usage indicator 160 may be red when the utility usage is above the upper threshold. In some embodiments, the lower and upper thresholds may be adjustable by the user of the system. In some embodiments, the lower and upper thresholds may be adjustable by a utility provider. In some embodiments, the lower and upper thresholds may be set by utility usage history. In yet other embodiments, the lower and upper thresholds may be set based on target financial parameters including, for example, utility cost and desired utility bill.

In other embodiments, the utility usage indicator 160 may change shapes indicating utility usage. One example may be the utility usage indicator 160 has the shape of a check mark ‘√’ if the utility usage is below a lower threshold, the utility usage indicator 160 may be a dash ‘-’ if the utility usage is between the lower threshold and a upper threshold, and the utility usage indicator 160 may be an exclamation mark ‘!’ if the utility usage is above the upper threshold. In other embodiments, the utility usage indicator 160 may use different characters, icons or shapes and/or a combination of shapes and colors to indicate utility usage. In other embodiments, the utility usage indicator 160 may be displayed as a meter with an indicator that moves to show the utility usage. The colors of the utility usage indicator 160 shown as a meter may change as discussed above in addition to the indicator movement. In other embodiments, the utility usage indicator 160 may have two states indicating usage above or below a single threshold. In yet other embodiments, the utility usage indicator 160 may have more than three states indicating usage between more than two thresholds. In at least one embodiment, the utility usage indicator 160 indicates the instantaneous utility usage. In some embodiments, the utility usage indicator 160 indicates cumulative utility usage. If the utility usage indicator 160 indicates cumulative usage, the cumulative usage may be reset. Resetting of the cumulative usage may occur automatically, for example at the beginning of the month or at a fixed date such as the beginning of a billing cycle. Resetting of the cumulative usage may occur manually through user action such as a menu option, user interface button, user input device such as a remote control, keyboard, mouse, or selection of a widget on the display image 100

The utility usage value 170 may represent a direct measurement of power or energy used such as a number of kilowatt-hours (kWh) of electricity, gallons of water, or British thermal unit (BTU) equivalents of natural gas. In other embodiments the utility usage value may be an indirect representation of the amount of energy used such as a percentage value of the monthly average usage of a household, a monetary value, or a composite number representing usage of several different utility products such as a composite number representing a combination of some number of different utility products including, but not limited to electricity, natural gas, water, sewer, or other utility products. In some embodiments the utility usage value 170 indicates the instantaneous utility usage. In other embodiments, the utility usage value 170 indicates cumulative utility usage. If the utility usage value 170 indicates cumulative usage, the cumulative usage may be reset. Resetting of the cumulative usage may occur automatically or manually.

FIG. 2 shows a data flow diagram 200 of an embodiment of a system for presenting a program schedule including utility usage information including a display 210, an interface 220, content data 230, program schedule data 240, utility usage data 250, interface to display communication coupling 260, content data to interface communication coupling 270, program schedule data to interface communication coupling 280, and usage data to interface communication coupling 290.

In at least one embodiment, the display 210 may be a display such as a television monitor. Other embodiments of the display 210 may include televisions (TVs), stationary or desktop computer displays, portable or notebook computer displays, tablet computer displays, a dedicated display, a multipurpose touchscreen display including control functions such as a thermostat, mobile communication device displays such as mobile phone or tablet displays, other displays, or a combination of displays. The display 210 may use different display technology including, but not limited to, cathode ray tube (CRT), plasma, liquid crystal display (LCD), light emitting diode (LED), organic light emitting diode (OLED), e-paper, or other types of display technology.

The display 210 is communicably coupled to the interface 220 through the interface to display communication coupling 260. One embodiment of the interface to display communication coupling 260 may include a High Definition Multimedia Interface (HDMI). Other embodiments of the interface to display communication coupling 260 may be a wireless interface such as wireless HDMI or modulation of the video signal on a carrier that may be demodulated by standard analog or digital TV tuners. Yet other embodiments of the interface to display communication coupling 260 may include composite video, component video, video graphics array (VGA), digital video interface (DVI), display port, radio frequency (RF), IEEE 802.11, code division multiple access (CDMA), GSM, WiMax, power line networking, another communication interface including proprietary interfaces, or a combination of communication couplings. In some embodiments, the interface 220 may be internal to the housing of the display 210, and the interface to display communication coupling 260 may be traces on a printed circuit board, or a connector between the interface 260 and the display 210.

The interface 220 receives content data 230 via the content data to interface communication coupling 270. In some embodiments, the content data is delivered in an MPEG transport stream via Internet protocol (IP) multicast and the content data to interface communication coupling 270 is a packet-switched network infrastructure. This embodiment may be referred to as internet protocol television (IPTV). Other embodiments provide content data as streaming data over the Internet. Yet other embodiments include video delivered using an RF signal modulated with an analog video signal or digital video stream. Such modulation may be done in accordance with any standard or proprietary technique including analog modulation according to national television system committee (NTSC), phase alternating line (PAL), or other analog modulation techniques. Digital modulation techniques that may be used include vestigial sideband (VSB) modulation according to advanced television systems committee (ATSC) standards, coded orthogonal frequency division multiplexing (COFDM) modulation according to digital video broadcast (DVB) standards, quadrature amplitude modulation (QAM), quadrature phase shift keying (QPSK) or other modulation techniques. The RF carrier may be any suitable frequency depending on the transmission type such as about 54-800 MHz for broadcast TV, about 2-20 GHz for satellite TV, about 950-2150 MHz for intermediate frequency (IF) transmission of satellite TV signals, about 7-800 MHz for cable television (CATV). Still other embodiments of the content data to interface communication coupling 270 may include, RF, Satellite, composite video, component video, VGA, DVI display port, IEEE 802.11, CDMA, GSM, WiMax, power line networking, another communication interface including proprietary interfaces, or a combination of communication couplings.

In some embodiments, the interface 220 may be referred to as a set-top box. The interface 220 may decode the content data 230 and output the decoded content to the display 210 via the interface to display communication coupling 260. The interface 220 may transcode the content data 230 and output the transcoded content to the display 210 via the interface to display communication coupling 260. The interface may directly output the content data 230 to the display 210 via the interface to display communication coupling 260.

The interface 220 receives program schedule data 240 via the program schedule data to interface communication coupling 280. Some embodiments may include the program schedule data 240 communicated on the same communicative coupling as the content data to interface 270 communication coupling. In other embodiments, the program schedule data 240 may be communicated over a distinct communicative coupling such as an Internet connection. In some embodiments where the program schedule data 240 is communicated via an IP connection, the program schedule data to interface communication coupling 280 may be the same packet switched network infrastructure on which the content data 230 is communicated, or the program schedule data to interface communication coupling 280 may use parts of the packet switched network infrastructure and parts distinct from the packet switched network infrastructure on which the content data 230 is communicated. In some embodiments program schedule data 240 may be communicated from the same provider of the content data 230. In other embodiments program schedule data 240 may be communicated from a provider of schedule information that is different from the provider of the content data 230. Other embodiments of the program schedule data to interface communication coupling 280 may include RF, satellite, IEEE 802.11, CDMA, GSM, WiMax, power line networking, another communication interface including proprietary interfaces, or a combination of communication couplings

The interface 220 receives utility usage data 250 via the utility usage data to interface communication coupling 290. In at least one embodiment the utility usage data may be communicated to the interface 220 from a utility meter. In other embodiments the utility usage data may be communicated to the interface 220 from a utility provider. In other embodiments some utility usage data, for example cumulative utility usage data may be communicated to the interface 220 from a utility provider and some utility usage data, for example instantaneous utility usage data, may be communicated to the interface 220 from a utility meter. In yet another embodiment, the utility usage data 250 may be communicated to the interface 220 from the content provider via the content data to interface communication coupling 270, the content provider may receive the utility usage information from one or both of a utility provider or a utility meter. In at least one embodiment the utility usage data to interface communication coupling 290 is a wireless network. Examples of such wireless networks may include among others IEEE 802.11, CDMA, GSM, ZigBee, and WiMax. In other embodiments the utility usage data to interface communication coupling 290 is a wired network. Examples of such wired networks may include among others RF cable, Ethernet, and power line networking.

Using the content data 230, program schedule data 240, and utility usage data 250, the interface 220 creates signals that are sent to the display 210 via the interface to display communication coupling 260. In at least one embodiment, the signals cause the display 210 to present a program schedule 110, a utility usage indicator 160, and a utility usage value 170. In other embodiments, the signals cause the display to present the program schedule 110, and a utility usage value 170. In other embodiments, the signals cause the display 210 to present the program schedule 110, and a utility usage indicator 160. In other embodiments, the signals may cause the display to present a program schedule 110, and one of more of the following: logo 120, date 130, weather indicator 140, temperature value 150, utility usage indicator 160, or utility usage value 170.

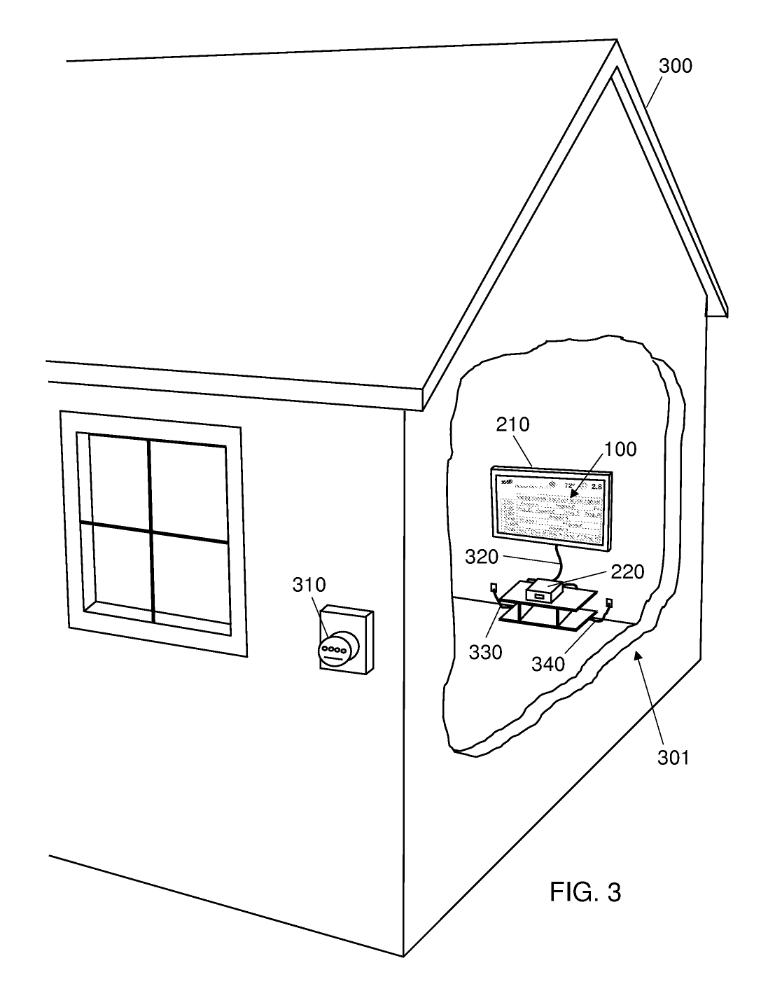

FIG. 3 shows a perspective view of an embodiment which provides a program schedule including utility usage information. Shown in the perspective view are: a home 300 with a cut-away wall 301, a display 210, with a display image 100 presenting a program schedule including utility information, and interface 220 communicatively coupled to the display 210 via the interface to display communication coupling 260, implemented in this embodiment, using an HDMI cable 320. The interface 220 receives content data 230 and program schedule data 240. In this embodiment, the content data to interface communication coupling 270 and the program schedule data to interface communication coupling 280 are the same physical cable which may be a digital cable TV cable 330. Other embodiments may receive the content data 230 and program schedule data 240 over a first Ethernet cable.

The interface 220 receives utility usage data 250 via the utility usage data to interface communication coupling 260. In this embodiment, the utility usage data to interface communication coupling 260 may be an Ethernet cable 340. Also shown in the perspective view is a utility meter 310. In this embodiment, the utility meter 310 is connected to the home network (not shown) and communicates utility usage data 250 to the interface 220 via the home network and ultimately the Ethernet cable 340.

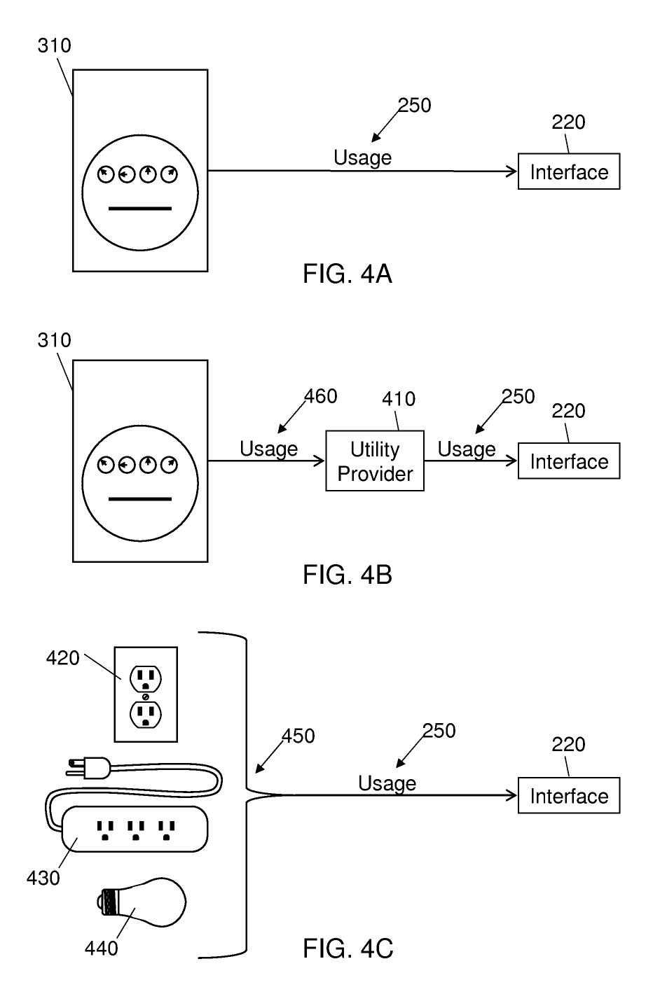

FIG.4A shows a data flow diagram of an embodiment with a utility meter 310 communicating utility usage data 250 to the interface 220. In some embodiments, the utility usage data 250 may be instantaneous usage data communicated at a fixed interval for example every 10 seconds. The interface 220 may accumulate the utility usage data 250 to allow presentation of cumulative usage. For example, the utility usage data 250 may be communicated in units of kilowatts (kW) and the interface 220 accumulates the utility usage data 250 into cumulative usage of kilowatt-hours (kWh). FIG. 4B shows a data flow diagram of an embodiment with a utility meter 310 communicating utility usage data 460 to a utility provider 410 and the utility provider 410 communicating utility usage data 250 to the interface 220. The utility provider 410 may modify the utility usage data 460 either in format or content before communicating the utility usage data 250 to the interface 220. In other embodiments the utility usage data 460 may be communicated to the utility provider 410 and the utility provider passes the utility usage data 460 on to the interface 220 with no modifications in which case utility usage data 460 and utility usage data 250 are the same. The utility provider 410 may accumulate the utility usage data 460 communicated from the utility meter 310 and communicate the instantaneous usage and the cumulative usage as the utility usage data 250 to the interface 220. The utility provider 410 may reset the cumulative usage periodically. The periodic reset may be at the beginning of each month, the beginning of each billing cycle, the beginning of a year, or other period. The utility provider 410 may also receive a signal (not shown) from the interface 220 prompting a reset of the cumulative usage. FIG. 4C shows a data flow diagram of an embodiment with outlets 420, power strip 430, and lights 440 communicating utility usage data 250 to the interface 220. In some embodiments the utility usage data to interface communication coupling 290 may be a Zigbee mesh network. Other devices that may communicate utility usage data to the interface may include appliances, air conditioning units, heating units, and water heaters. In such embodiments the interface 220 receives the utility usage data from the devices communicating utility usage data 250 and accumulates the devices’ instantaneous usage data 250 into a single instantaneous usage. In some embodiments the interface 220 may also store the instantaneous usage communicated by each device to present the usage of each device. In some embodiments the interface 220 may also accumulate and store the usage of each device in order to provide total cumulative utility usage as well as cumulative utility usage per device.

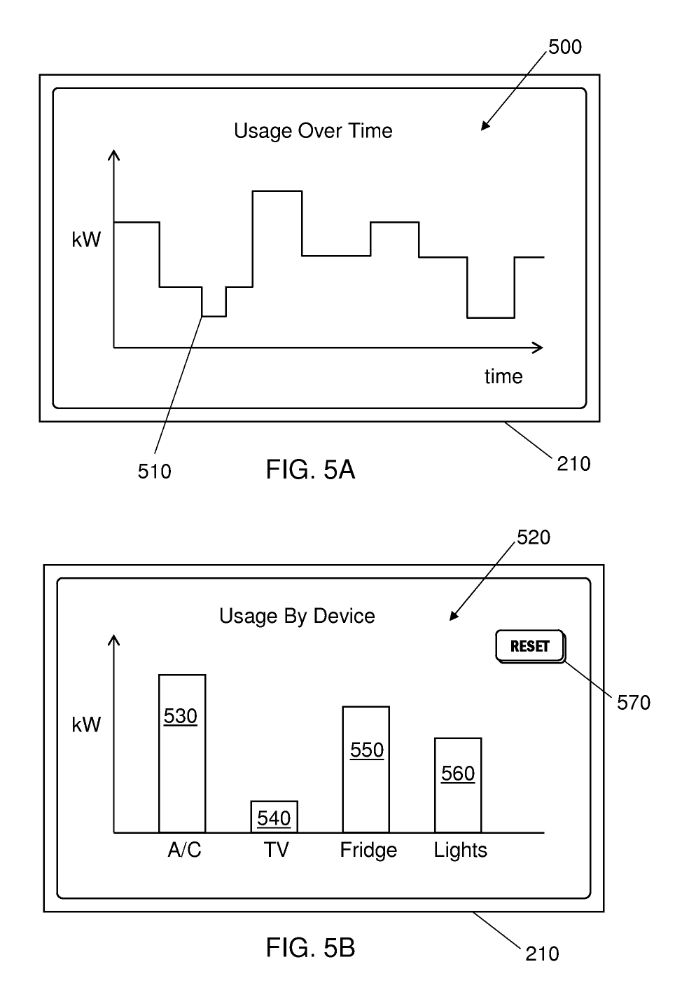

FIG. 5A is a representation of detailed utility usage 500 presenting a utility usage over time graph 510. In some embodiments the time scale of the graph 510 may be a sliding 24 hours. In other embodiments the time scale on the graph 510 may be 24 hours starting at midnight. In yet other embodiments the time scale on the graph 510 may encompass a month or a billing period. FIG. 5B is a representation of utility usage per device 520 presenting utility usage per device. This type or presentation may be referred to as a bar chart. In some embodiments, the utility usage per device is displayed as the instantaneous utility usage for the device. In some embodiments the utility usage per device is displayed as the cumulative utility usage for the device. In some embodiments, the electrical usage for one or more Air Conditioners 530, one or more TVs 540, one or more refrigerators 550, and one or more lights 560 is presented. In other embodiments, natural gas usage may be presented in place of or in addition to other utility usage data. In yet other embodiments, water usage may be presented, alone or with other utility usages. In some embodiments the presentation of utility usage information per device includes a reset widget 570. In at least one embodiment the reset widget 570 would set the cumulative usage of each device to zero. In other embodiments the reset widget 570 may reset the total cumulative usage to zero. In other embodiments presentation of usage over time 500 is triggered by the user selecting the utility usage indicator 160 from the display image 100 showing a program schedule including utility information. In other embodiments presentation of usage by device 520 is triggered by the user selecting the utility usage indicator 160 from the display image 100.

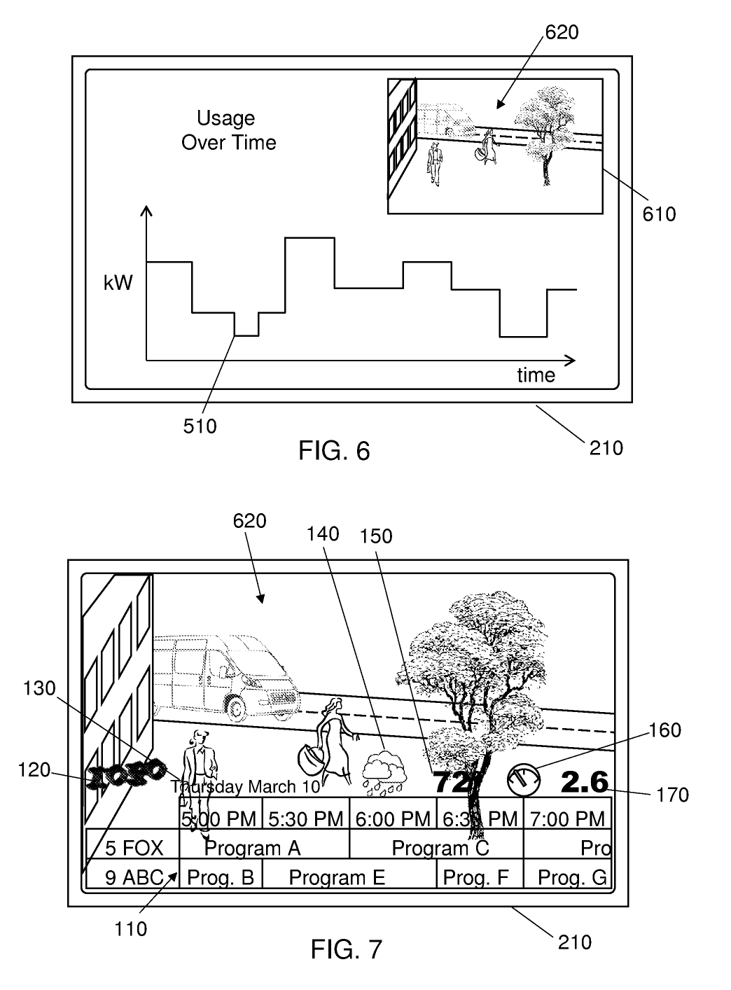

FIG. 6 is a representation of detailed utility usage 510 with a program 620 displayed in a window 610. In some embodiments presentation of detailed utility usage 510 with the content displayed in a window is triggered by the user selecting the utility usage value 170 from display image 100 showing the program schedule including utility information. In some embodiments selecting the content window 610 swaps the detailed utility usage 510 into the window 610 and the program 620 to where the detailed utility usage was displayed.

FIG. 7 is a representation of a program schedule including utility usage information where the program schedule 110 is presented on less than the full screen. In at least one embodiment the program schedule including utility usage information 100 is presented overlaid on a portion of the program 620. In at least one embodiment, the program schedule including utility usage information 100 is presented with a perceived transparency allowing the program 620 to be perceived along with the overlaid program schedule including utility usage information 100.

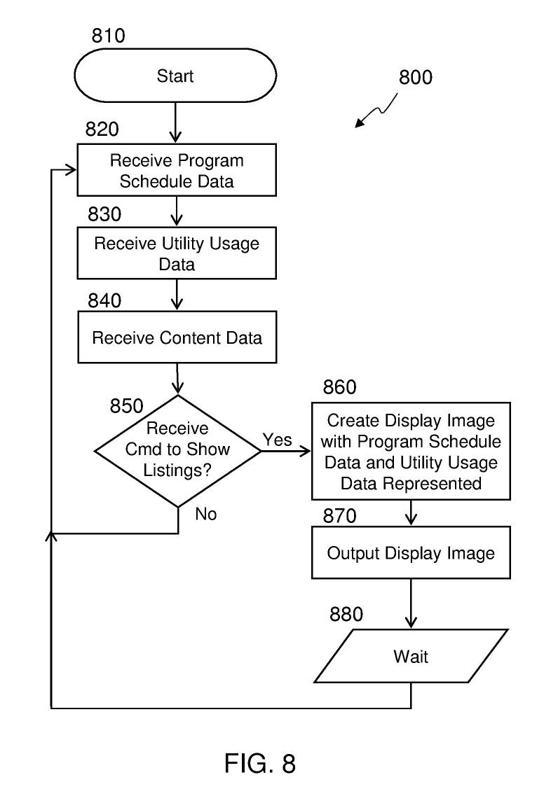

FIG. 8 shows a flow chart 800 of an embodiment for a method of presenting a program schedule including utility usage information. The methods described may be embodied as circuitry, a hardware state machine, a processor executing firmware, a general purpose computer running a computer program from a non-transitory computer readable storage medium, or any combination of those elements and/or other means.

An interface 220 may determine to start receiving data at block 810. In many embodiments this may occur soon after the interface 220 is powered on as a part of the initialization process of the interface 220. In some embodiments, the interface 220 may start receiving data at some regular interval, such as once per hour, once per day, once per week, once per month, or any other interval. The interface 220 may receive some data at different intervals than other data. For example, some embodiments may receive program schedule data 240 once per day, receive utility usage data 250 one per minute, and receive content data 230 every second. In some embodiments, the program schedule data 240 and the program content data 230 may be interleaved on a common interface. In some embodiments, the utility usage data 250 may be aggregated for use in creating another representation of the utility usage data 250.

At block 820, the interface may receive program schedule data 240. The program schedule data 240 may be received via a program schedule data to interface communication coupling 280. At block 830, the interface may receive utility usage data 250. The utility usage data 250 may be received via the utility usage data to interface communication coupling 290. At block 840, the interface may receive content data 230. The content data 230 may be received via the content data to interface communication coupling 270. In some embodiments, the received data may be stored for later use in creating screen image with program schedule data and utility usage data represented.

An interface 220 may determine to whether or not to output the display screen 100 at block 850. In some embodiments, at block 850, the interface 220 determines if a command to output the display screen has been received. The command to output the display screen may be transmitted over the content data to interface communication coupling 270 or the program schedule data to interface communication coupling 280, or the utility usage data to interface communication coupling 290, or another communication coupling for example, an infra-red (IR) remote control coupling, an RF remote control coupling, a universal serial bus (USB) human interface device (HID), a mouse, a keyboard, or another input device.

At block 850, if the command to output the display screen has not been received, in some embodiments, an interface 220 may continue to receive data. At block 850, if the command to output the display screen has been received, in some embodiments, an interface 220 may create, at block 860, a display image 100 with program schedule data and utility usage data represented. At block 870 the display image 100 is output. In some embodiments, the display image 100 is output via the interface to display communication coupling 260.

At block 880, in some embodiments, the interface 220, may delay or wait for an interval before receiving more data. The interface may wait until a command to stop the output of the display screen 100 with program schedule data and utility usage data representation.

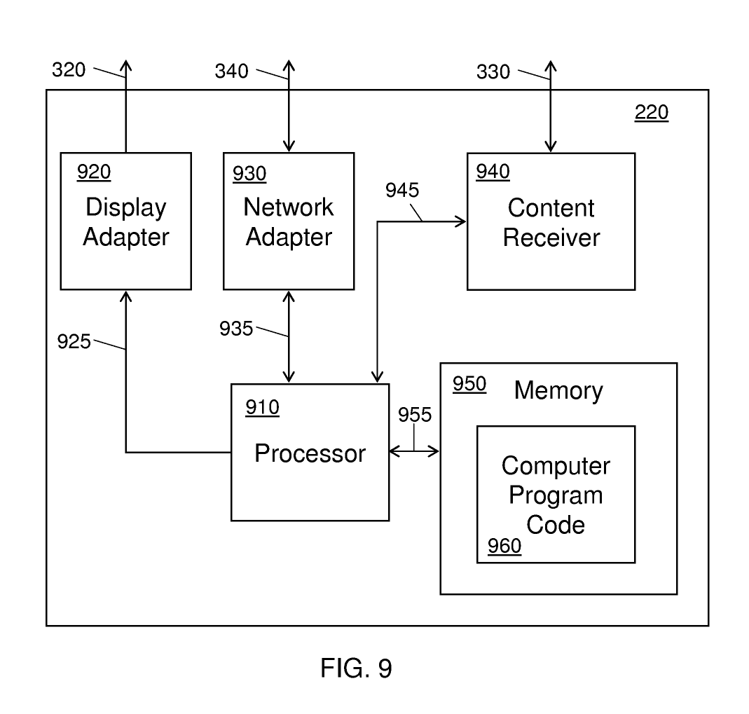

FIG. 9 shows a hardware block diagram of an embodiment of an interface 220 suitable for use in presenting a program schedule including utility usage. The interface 220 may have a processor 910 capable of executing computer instructions implementing computer programs having various functions. The processor 910 may be coupled to a display adapter 920 by a processor to display adapter communications connection 925, allowing the processor 910 and display adapter 920 to send instructions and/or data to one another. The display adapter 920 may have a connection, for example an HDMI cable 320, suitable for connecting to a display. Other embodiments of the display adapter connection may include composite video, component video, video graphics array (VGA), digital video interface (DVI), display port, radio frequency (RF), IEEE 802.11, code division multiple access (CDMA), GSM, WiMax, power line networking, another communication interface including proprietary interfaces, or a combination of communication couplings.

The processor 910 may be coupled to a network adapter 930 by a processor to network adapter communications connection 935, allowing the processor 910 and network adapter 930 to send instructions and/or data to one another. The network adapter 930 has a network connection, for example an Ethernet cable 340, suitable for connecting to a network. The network adapter 930 may be configured to support any type of computer network, including wired networks, RF networks, power line communication networks, and optical networks. Wired networks that could be used include, but are not limited to, various speeds and configurations of IEEE 802.3 Ethernet networking, infiniband, Multimedia over Coax Alliance (MoCA), or other standard and/or proprietary protocols. RF networks that could be used include, but are not limited to, various version of IEEE 802.11, wireless mesh networks such as IEEE 802.15.4 ZigBee or Z-Wave, IEEE 802.16 WiMax and other “wireless” networks, standards based or proprietary, utilizing radio frequency communication. Power line communication networks that could be used include, but are not limited to, protocols published by the Home Plug Powerline Alliance, the Universal Powerline Association, the HD_PLC Alliance, the ITU-T, or other standards based or proprietary powerline communication protocols. In some embodiments, the interface 220 may have more than one network interface and network connection, allowing it to communicate over multiple networks that may implement the same of different protocols or types of networking.

The processor 910 may be coupled to a content receiver 940 by a processor to content receiver communications connection 945, allowing the processor 910 and content receiver 940 to send instructions and/or data to one another. The content receiver 940 may have a connection, for example a digital TV cable 330 suitable for connecting to a TV content provider network. The content receiver 940 may be configured to support any type of content delivery system, including, but not limited to, IPTV, NTSC, ATSC, PAL, VSB, COFDM, DVB, QAM, CATV, another content delivery system including proprietary systems, or a combination thereof. In some embodiments, the content receiver 940 and the network adapter 930 may be configured to support the same network and share a single connection.

The interface 220 may include memory 950 or other non-transitory computer readable storage medium coupled to the processor 910 with the processor to to memory communications connection 955. The memory 950 may be implemented using dynamic random access memory (DRAM), synchronous dynamic random access memory (SDRAM), double data rate random access memory (DDR), NOR or NAND type flash memory, static random access memory (SRAM), electrically erasable programmable read only memory (EEPROM), read only memory (ROM), programmable read only memory (PROM), hard disk, CD ROM, DVD ROM, or any other computer readable storage medium, volatile or non-volatile. The memory 950 may hold computer program code 960 that is readable and executable by the processor 910. The computer program code 960 may be configured to implement the methods described above including the method shown in flow chart 800.

In some embodiments, the processor 910, display adapter 920, network 930, content receiver 940, and memory 950 may be implemented into a single semiconductor die and/or a single package. In some embodiments, the processor 910, display adapter 920, network 930, content receiver 940, and memory 950 may be implemented into a plurality of semiconductor dies and/or packages. In some embodiments, the processor 910, display adapter 920, network 930, content receiver 940, and memory 950 may each be implemented into separate semiconductor dies and/or packages.

Unless otherwise indicated, all numbers expressing quantities of elements, optical characteristic properties, and so forth used in the specification and claims are to be understood as being modified in all instances by the term “about.” Accordingly, unless indicated to the contrary, the numerical parameters set forth in the preceding specification and attached claims are approximations that can vary depending upon the desired properties sought to be obtained by those skilled in the art utilizing the teachings of the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviations found in their respective testing measurements.

As used in this specification and the appended claims, the singular forms “a”, “an”, and “the” include plural referents unless the content clearly dictates otherwise. Thus, for example, reference to an element described as “an LED” may refer to a single LED, two LEDs or any other number of LEDs. As used in this specification and the appended claims, the term “or” is generally employed in its sense including “and/or” unless the content clearly dictates otherwise.

As used herein, the term “coupled” includes direct and indirect connections. Moreover, where first and second devices are coupled, intervening devices including active devices may be located there between.

Any element in a claim that does not explicitly state “means for” performing a specified function, or “step for” performing a specified function, is not to be interpreted as a “means” or “step” clause as specified in 35 U.S.C. §112, ¶6.

The description of the various embodiments provided above is illustrative in nature and is not intended to limit the invention, its application, or uses. Thus, variations that do not depart from the gist of the invention are intended to be within the scope of the embodiments of the present invention. Such variations are not to be regarded as a departure from the intended scope of the present invention.

What is claimed is:

1. A method for presenting utility usage information while viewing program schedule information comprising:
receiving program schedule data;
receiving utility usage data; and
directing a display to present a program schedule that includes a representation of the program schedule data and a representation of the utility usage data.

2. The method of claim 1, wherein the utility usage data is electric utility usage data.

3. The method of claim 1, wherein the representation of the utility usage data is a numeric value representing an instantaneous utility usage.

4. The method of claim 1, wherein the representation of the utility usage data is a numeric value representing a cumulative utility usage.

5. The method of claim 1, wherein the representation of the utility usage data is an indicator.

6. The method of claim 5, further comprising:
indicating a utility usage is above a threshold.

7. A system for presenting utility usage information while viewing program schedule information comprising:
means for receiving program schedule data;
means for receiving utility usage data; and
means for directing a display to present a program schedule that includes a representation of the program schedule data and a representation of the utility usage data.

8. The system of claim 7, wherein the utility usage data is electric utility usage data.

9. The system of claim 7, wherein the representation of the utility usage data is a numeric value representing an instantaneous utility usage.

10. The system of claim 7, wherein the representation of the utility usage data is a numeric value representing a cumulative utility usage.

11. The system of claim 7, wherein the representation of the utility usage data is an indicator.

12. The system of claim 11, further comprising:
means for indicating a utility usage is above a threshold.

13. A computer program product for displaying program schedule data and utility usage data, the computer program product comprising:
a non-transitory computer readable storage medium having computer readable program code embodied therewith, the computer readable program code comprising:
computer readable program code configured to receive program schedule data and utility usage data; and
computer readable program code configured to direct a display to present a program schedule that includes a representation of the program schedule data and the utility usage data.

14. The computer program product of claim 13, wherein the utility usage data is electric utility usage data.

15. The computer program product of claim 13, wherein the utility usage data representation is a numeric value representing an instantaneous utility usage.

16. The computer program product of claim 13, wherein the utility usage data representation is a numeric value representing a cumulative utility usage.

17. The computer program product of claim 13, wherein the utility usage data representation is an indicator.

18. The computer program product of claim 17, further comprising:
computer readable program code configured to change the indicator based on one or more thresholds.

19. The computer program product of claim 13, further comprising:
computer readable program code configured to direct a display to present detailed utility usage.

20. An entertainment interface comprising:
the computer program product of claim 13;
a processor, said processor communicatively coupled to the non-transitory computer readable storage medium and capable of retrieving and executing the computer readable program code; and
circuitry communicatively coupled to said processor and configured to receive said program schedule data and said utility usage data.

21. The entertainment interface of claim 20, further comprising:
circuitry communicatively coupled to said processor and configured to receive content data;
wherein the computer readable program code further comprises:
computer readable program code configured to direct a display to present said content data.
